(19) United States
(12) Patent Application Publication
(10) Pub. No.: US 2006/0160000 A1
(43) Pub. Date: Jul. 20, 2006

(54) Electrolyte for lithium rechargeable battery and lithium rechargeable battery comprising the same

(76) Inventor: Jin Hee Kim, Yongin-si (KR)

Correspondence Address: CHRISTIE, PARKER & HALE, LLP, PO BOX 7068, PASADENA, CA, 91109-7068, US

(21) Appl. No.: 11/334,757

(22) Filed: Jan. 17, 2006

(30) Foreign Application Priority Data
Jan. 14, 2005 (KR) 10-2005-0003692

(51) Int. Cl. H01M 10/40

(52) U.S. Cl. 429/332; 429/200

(57) ABSTRACT

An electrolyte for a lithium rechargeable battery is provided. The electrolyte improves the low-temperature discharge and cycle life characteristics of the lithium rechargeable battery while maintaining the overcharge safety of the battery. The electrolyte comprises: a lithium salt; a non-aqueous organic solvent comprising a cyclic carbonate and a linear carbonate; and an electrolyte additive represented by Formula 1. 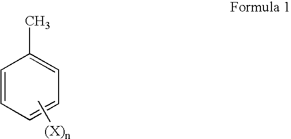 wherein X is Cl, n is an integer ranging from 1 to 5, and at least one Cl is substituted at the para-position. The electrolyte additive is present in the electrolyte in an amount ranging from about 5 to about 10% by volume based on the total volume of the electrolyte. The cyclic carbonate is present in an amount ranging from about 20 to about 25% by volume based on the total volume of the electrolyte.

### CROSS REFERENCE TO RELATED APPLICATION

This application claims priority to and the benefit of Korean Patent Application No. 2005-0003692 filed on Jan. 14, 2005 in the Korean Intellectual Property Office, the entire content of which is incorporated herein by reference.

### FIELD OF THE INVENTION

The present invention relates to an electrolyte for lithium rechargeable batteries and a lithium rechargeable battery comprising the same. More particularly, the invention is directed to an electrolyte which improves overcharge safety, low-temperature discharge and cycle life characteristics of lithium rechargeable batteries, and to a lithium rechargeable battery comprising the same.

### BACKGROUND OF THE INVENTION

Recent, rapid developments in the electronics, telecommunications and computer industries have led to increased use of portable electronic products, such as camcorders, cellular phones and notebook PCs. These developments have also led to decreases in the size and weight of the portable devices and increases in function, resulting in increased demand for highly reliable batteries. Lithium rechargeable batteries are being heavily researched due to their high energy densities per unit weight and their ability to be rapidly charged. Specifically, lithium rechargeable batteries have energy densities about three times greater than existing lead acid batteries, nickel-cadmium batteries, nickel-zinc batteries, etc.

A typical lithium rechargeable battery comprises a positive active material, a negative active material and an electrolyte. The positive active material comprises a lithium-containing metal oxide, such as lithium cobalt oxide (LiCoO₂), lithium nickel oxide (LiNiO₂), lithium manganese oxide (LiMnO₂) or the like, which can intercalate and deintercalate lithium ions. The negative active material comprises a lithium metal or a lithium-containing metal capable of reversibly accepting or donating lithium ions while maintaining structural and electrical properties. Alternatively, the negative active material comprises a carbonaceous material having a chemical potential similar to that of a lithium metal upon the intercalation/deintercalation of lithium ions. The electrolyte consists of a suitable amount of lithium salt dissolved in a mixed organic solvent. Lithium rechargeable batteries are classified into lithium ion batteries or lithium polymer batteries, according to the properties of the solvent used in the electrolyte.

Lithium batteries having negative electrodes comprising a lithium metal or lithium alloy have a risk of explosion resulting from battery short-circuits caused by the formation of dendrites. For this reason, these metal batteries have been substituted with lithium ion batteries, which include negative active materials consisting of carbonaceous materials having a reduced risk of explosion. These lithium ion batteries have improved battery cycle life and stability compared to the lithium metal batteries, because the electrode active materials in the lithium ion batteries remain intact. However, only lithium ions migrate during charge and discharge.

Methods for improving battery safety characteristics (e.g. overcharge characteristics) while also improving battery capacity and performance characteristics have been actively researched. When batteries are overcharged, lithium is excessively deposited in the positive electrode and excessively intercalated in the negative electrode. As a result, the positive and negative electrodes become thermally unstable, causing a rapid exothermic reaction (i.e. the decomposition of the organic solvent) and thermal runaway, seriously compromising the safety of the battery.

### SUMMARY OF THE INVENTION

In one embodiment of the present invention, an electrolyte for a lithium rechargeable battery is provided which improves overcharge safety, low-temperature discharge and cycle life characteristics of the battery.

In another embodiment of the present invention, a lithium rechargeable battery comprises the electrolyte.

In one embodiment, the electrolyte for a lithium rechargeable battery comprises: a lithium salt; a non-aqueous organic solvent comprising a mixture of cyclic carbonates and linear carbonates; and an electrolyte additive represented by Formula 1. The electrolyte additive is present in the electrolyte in an amount ranging from about 5 to about 10% by volume based on the total volume of the electrolyte. The cyclic carbonate is present in the electrolyte in an amount ranging from about 20 to about 25% by volume based on the total volume of the electrolyte. 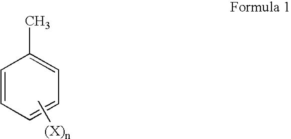
wherein X is Cl, n is an integer ranging from 1 to 5, and at least one Cl is substituted at the para-position.

In another embodiment, the electrolyte for a lithium rechargeable battery comprises: a lithium salt, a non-aqueous solvent comprising a mixture of cyclic carbonates and linear carbonates; and an electrolyte additive represented by Formula 1. The electrolyte additive is present in the electrolyte in an amount ranging from about 5 to about 10% by volume based on the total volume of the electrolyte, and the lithium salt is has a concentration ranging from about 0.8 to about 1.2 M.

In still another embodiment, a lithium rechargeable battery comprises: the above-described electrolyte; a positive electrode comprising a positive active material capable of reversibly intercalating and deintercalating lithium ions; and a negative electrode comprising a negative active material capable of reversibly intercalating and deintercalating lithium ions.

### BRIEF DESCRIPTION OF THE DRAWINGS

FIGS. 1a and 1b are graphical representations of low-temperature discharge characteristics of lithium rechargeable batteries according to Examples 1 through 11 and Comparative Examples 1 through 11; and

FIG. 2 is a schematic of a battery according to one embodiment of the present invention.

### DETAILED DESCRIPTION OF THE INVENTION

In a lithium rechargeable battery, thermal runaway occurs when the temperature of the battery increases abruptly due to overcharge or a short circuit. Overcharge can result from incorrect operation or break-down of the battery charger, and a short-circuit can be caused by a defect in battery design. In particular, during overcharge an excessive amount of lithium ions are released from the positive electrode and deposited on the surface of the negative electrode, causing the two electrodes to become thermally unstable. As a result, exothermic reactions rapidly progress, such as pyrolysis of the electrolyte (i.e. a reaction between the electrolyte and lithium), oxidation of the electrolyte due to the generation of oxygen gas during pyrolysis of the positive active material, and the like. These exothermic reactions cause thermal runaway due to rapid temperature increases inside the battery. The thermal runaway leads to the generation of fire and smoke.

In one embodiment of the present invention, an electrolyte for a lithium rechargeable battery is provided which increases battery safety during overcharge and improves battery cycle life and temperature characteristics, including battery performance at low temperatures.

In one embodiment, the electrolyte includes an electrolyte additive represented by Formula 1 below. Use of this additive generates heat by oxidation at more than 4.5 V, thereby rapidly increasing the temperature of the electrolyte. During overcharge, the separator is shut down by the temperature of the electrolyte before thermal runaway occurs. Therefore, the electrolyte additive inhibits thermal runaway. 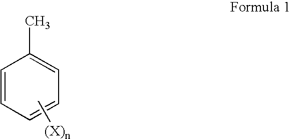
wherein X is Cl, n is an integer ranging from 1 to 5, and at least one Cl is substituted at the para-position.

Nonlimiting examples of suitable materials for use as the electrolyte additive include 4-chlorotoluene, 2,4-dichlorotoluene, 3,4-dichlorotoluene, 2,3,4-trichlorotoluene, 3,4,5-trichlorotoluene, 2,3,4,5-tetrachlorotoluene, 2,3,4,6-tetrachlorotoluene, 2,3,4,5,6-pentachlorotoluene, and mixtures thereof. Cl substituted toluenes and halogenated toluenes substituted with Cl at the para-position have excellent overcharge safety.

In a lithium rechargeable battery, the ion conductivity of the electrolyte greatly influences the charge/discharge performance and rapid charge performance of the battery. Therefore, ion conductivity should be high. To achieve high ion conductivity, the electrolyte has a high dielectric constant and low viscosity to make the migration of lithium ions in the electrolyte easier. Also, the electrolyte has a low solidifing point because, if the electrolyte solidifies at low temperatures, the migration of ions will be limited, making the charge/discharge of the battery difficult. Accordingly, to achieve high ion conductivity of the electrolyte, a high-dielectric solvent and a low-viscosity solvent are mixed with a solvent having a low freezing point. Such an electrolyte improves battery performance at low temperatures.

However, mobility of lithium ions markedly decreases at low temperatures, particularly at about −20° C. Thus, even with the above-described solvent composition, it may still be difficult to prevent rapid reductions in the discharge characteristics of the battery due to rapid increases in internal resistance upon high rate discharge.

In one embodiment of the present invention, a lithium salt is mixed with a solvent comprising a mixture of cyclic carbonates and linear carbonates. An electrolyte additive represented by Formula 1 is added as an overcharge-preventing agent in an amount ranging from about 5 to about 10% by volume based on the total volume of the electrolyte. If the electrolyte additive is added in an amount more than about 10% by volume, the overcharge safety of the battery will be improve, but the low-temperature discharge capacity of the battery will rapidly decrease, leading to deteriorated low-temperature performance of the battery. If the amount of cyclic carbonate or the amount of the lithium salt is reduced to inhibit deterioration of low-temperature performance, the low-temperature discharge characteristics can be maintained even when the content of the electrolyte additive is increased. However, if the content of cyclic carbonate or the content of the lithium salt is excessively reduced, the cycle life characteristics of the battery may deteriorate.

In order to maintain low-temperature discharge and cycle life characteristics of the battery while improving overcharge safety, an electrolyte according to one embodiment of the present invention contains the electrolyte additive in an amount ranging from about 5 to about 10% by volume based on the total volume of the electrolyte, and contains the cyclic carbonate in an amount ranging from about 20 to about 25% by volume based on the total volume of the electrolyte. In an alternative embodiment, the electrolyte contains the electrolyte additive in an amount ranging from about 5 to 10% by volume based on the total volume of the electrolyte, and the lithium salt has a concentration ranging from about 0.8 to about 1.2 M. In another embodiment, the lithium salt has a concentration ranging from about 0.8 to about 1.0 M.

If the content of the electrolyte additive represented by Formula 1 is less than 5% by volume relative to volume of the electrolyte, it will have insignificant overcharge-preventing effects, and if it is more than 10% by volume, it can reduce the cycle life of the battery.

If the cyclic carbonate is present in an amount less than about 20% by volume based on the total volume of the electrolyte, the cycle life characteristics of the battery will deteriorate. If the cyclic carbonate is present in the electrolyte in an amount more than about 25% by volume, the low-temperature discharge capacity of the battery will rapidly deteriorate.

To improve the low-temperature discharge and cycle life characteristics of the battery, the lithium salt is used at a concentration ranging from about 0.8 to about 1.2 M. In another embodiment, the concentration ranges from about 0.8 to about 1.0 M. If the concentration of the lithium salt is less than about 0.8 M, the conductivity of the electrolyte decreases, leading to a reduction in the cycle life characteristics of the battery. If the concentration of the lithium salt is more than about 1.2 M, the viscosity of the electrolyte undesirably increases.

Nonlimiting examples of cyclic carbonates suitable for use in the present invention include ethylene carbonate (EC), propylene carbonate (PC), 1,2-butylene carbonate, 2,3-butylene carbonate, 1,2-pentylene carbonate, 2,3-pentylene carbonate, vinylene carbonate (VC), and the like. In one embodiment, the cyclic carbonate is selected from the group consisting of ethylene carbonate and propylene carbonate, which have high dielectric constants. If artificial graphite is used as the negative active material, ethylene carbonate can be used as the cyclic carbonate.

Nonlimiting examples of linear carbonates suitable for use in the present invention include dimethyl carbonate (DMC), diethyl carbonate (DEC), dipropyl carbonate (DPC), methyl propyl carbonate (MPC), ethyl methyl carbonate (EMC), ethyl propyl carbonate (EPC), and the like. In one embodiment, the linear carbonate is selected from the group consisting of dimethyl carbonate, ethyl methyl carbonate and diethyl carbonate, which have low viscosities.

The non-aqueous organic solvent may further comprise an organic aromatic hydrocarbon solvent. In one embodiment, the organic aromatic hydrocarbon solvent is a hydrocarbon compound represented by Formula 2, below. 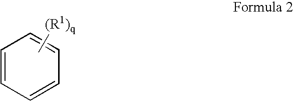
where R¹ is a halogen or an alkyl group having 1 to 10 carbon atoms, and q is an integer ranging from 0 to 6.

Nonlimiting examples of organic aromatic hydrocarbon solvents suitable for use with the present invention include benzene, fluorobenzene, bromobenzene, chlorobenzene, toluene, xylene, mesitylene, and mixtures thereof. The volume ratio of the carbonate solvent to the organic aromatic hydrocarbon solvent ranges from about 1:1 to about 30:1. When the volume ratio is within this range, the electrolyte exhibits improved performance.

The lithium salt in the inventive electrolytes serves as the source of lithium ions in the battery, enabling the fundamental operation of the lithium battery. The non-aqueous organic solvent serves as a medium through which the ions involved in the electrochemical reactions migrate. The lithium salt may be selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₄, LiAlCl₄, LiN(CₓF₂ₓ₊₁SO₂)(C_{y}F_{2y+1}SO₂) (x and y=natural numbers), LiCl, Lil, and mixtures thereof.

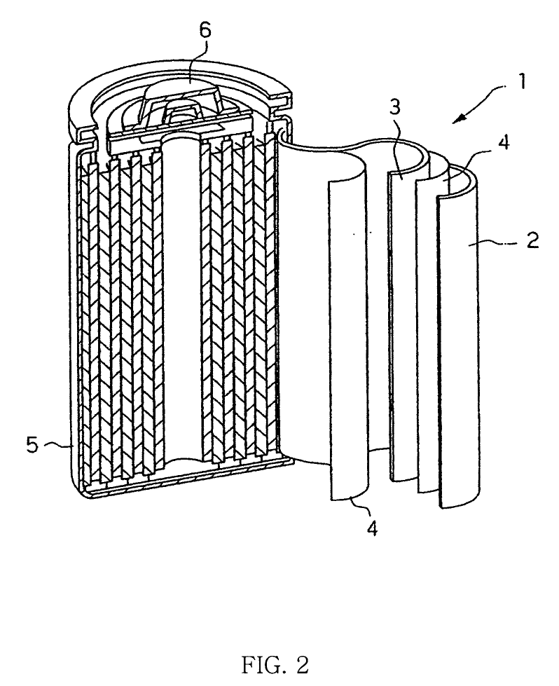

In another embodiment of the present invention, as shown in FIG. 2, a lithium rechargeable battery 1 includes an electrolyte as described above, a positive electrode 2 and a negative electrode 3. The positive electrode 2 comprises a positive active material capable of intercalating and deintercalating lithium ions. This positive active material may be a lithium-containing transition metal compound or a lithium chalcogenide compound. Nonlimiting examples of suitable positive active materials include metal oxides, such as LiCoO₂, LiNiO₂, LiMnO₂, LiMn₂O₄, and LiN_{1-x-y}CoₓM_{y}O₂ (0≦x≦1, 0≦y≦1, 0≦x+y≦1, M=metal, e.g., Al, Sr, Mg, or La).

The negative electrode 3 comprises a negative active material capable of intercalating and deintercalating lithium ions. This negative active material can include a carbonaceous material such as crystalline carbon, amorphous carbon, carbon composite or carbon fiber. Nonlimiting examples of suitable amorphous carbon materials include hard carbon, coke, mesocarbon microbead (MCMB) sintered below 1500° C., mesophase pitch-based carbon fiber (MPCF) and the like. Nonlimiting examples of suitable crystalline carbon materials include graphite-based materials, such as natural graphite, graphitized coke, graphitized MCMB, graphitized MPCF and the like. In one embodiment, the carbonaceous material has a d002 interplanar distance ranging from about 3.35 to about 3.38 Å, and an Lc (crystallite size) of more than 20 nm as measured by X-ray diffraction.

Alternatively, the negative active material can comprise a lithium metal, a lithium alloy, or the like. The lithium alloy may be an alloy of lithium with aluminum, zinc, bismuth, cadmium, antimony, silicon, lead, tin, gallium or indium.

The positive or negative electrodes may be fabricated by dispersing an active material, a binder, and a conductive material in a solvent, to prepare a slurry composition. The slurry may further comprises a thickener, if necessary. The slurry composition is applied to an electrode current collector. The positive electrode current collector may be made of aluminum or an aluminum alloy, and the negative electrode current collector may be made of copper or a copper alloy.

The binder has many purposes, for example, pasting the active material, adhesion to the active material, adhesion to the current collector, buffering against swelling and shrinkage of the active materials, etc. Nonlimiting examples of suitable binders include polyvinylidene fluoride, polyhexafluoropropylene-polyvinylidenefluoride copolymers (P(VdF/HFP)), poly(vinyl acetate), polyvinyl alcohol, polyethylene oxide, polyvinyl pyrrolidone, alkylated polyethylene oxide, polyvinyl ether, poly(methylmethacrylate), poly(ethylacrylate), polytetrafluoroethylene, polyvinyl chloride, polyacrylonitrile, polyvinyl pyridine, styrene-butadiene rubber, acrylonitrile-butadiene rubber, and the like. The binder is present in an amount ranging from about 1 to about 10% by weight based on the total weight of the electrode active material. If the binder is present in an amount less than about 1% by weight, the adhesion between the electrode active material and the current collector is insufficient. If the binder is present in an amount more than about 10% by weight, the adhesion is increased but battery capacity is decreased due to a corresponding reduction in the content of the electrode active material.

The conductive material serves to increase electron conductivity. Nonlimiting examples of suitable conductive materials include graphite (e.g., artificial graphite, natural graphite, etc.), carbon blacks (e.g., acetylene black, kechen black, denka black, thermal black, channel black, etc.), conductive fibers (e.g., carbon fibers, metal fibers, etc.), metal powders (e.g., copper, nickel, aluminum, silver, etc.), conductive metal oxides (e.g., titanium dioxide), conductive polymers (e.g., polyaniline, polythiophene, polyacetylene, polypyrrol), and mixtures thereof. In one embodiment, the conductive material is present in an amount from about 0.1 to about 10% by weight based on the total weight of the electrode active material. In another embodiment, the conductive material is present in an amount ranging from about 1 to about 5% by weight based on the total weight of the electrode active material. If the conductive material is present in an amount less than about 0.1% by weight, the electrochemical properties of the battery deteriorate. If the conductive material is present in an amount more than about 10% by weight, energy density per weight is reduced.

The thickener can be any material capable of adjusting the viscosity of the active material slurry. Nonlimiting examples of suitable thickeners include carboxymethyl cellulose, hydroxymethyl cellulose, hydroxyethyl cellulose, hydroxypropyl cellulose, and the like.

In one embodiment, the lithium rechargeable battery 1 comprises a separator 4 that prevents short-circuits between the positive and negative electrodes and provides passages for the migration of lithium ions. This separator 4 may be made of any known material. Nonlimiting examples of suitable materials for the separator include polyolefin-based polymer films and multilayers thereof, such as polypropylene or polyethylene, microporous films, woven fabrics and non-woven fabrics. Moreover, the separator 4 may be made of a porous polyolefin film coated with a resin having good stability.

As shown in FIG. 2, to fabricate the lithium battery 1, the positive electrode 2, negative electrode 3 and the separator 4 are wound to form an electrode assembly. The electrode assembly is then placed inside a can 5, the electrolyte is injected into the can 5, and the can 5 is sealed with a cap assembly 6.

Hereinafter, the present invention will be described in detail by examples and comparative examples. It is to be understood, however, that these examples are presented for illustrative purpose only, and are not to be construed as limiting the scope of the present invention.

### EXAMPLE 1

An artificial graphite negative active material was suspended in an aqueous solution of carboxymethyl cellulose. A styrene-butadiene rubber binder was added to the suspension, thereby preparing a negative active material slurry. The negative active material slurry was coated on a 10-μm thick copper foil, and then dried and rolled to fabricate a negative electrode.

A LiCoO₂ positive active material, a polyvinylidene fluoride binder and a carbon conductive agent (Super P) were dispersed in N-methyl-2-pyrrolidone in a weight ratio of 92:4:4, to prepare a positive active material slurry. The positive active material slurry was coated on a 15-μm thick aluminum foil, and then dried and rolled to fabricate a positive electrode.

A separator was positioned between the positive and negative electrodes and the combination was wound to fabricate an electrode assembly. The electrode assembly was inserted into a can, and an electrolyte was then introduced into the can, thereby fabricating a lithium rechargeable battery.

The electrolyte was prepared by adding 1.3 M LiPF₆ to a mixed solvent of ethylene carbonate, ethyl methyl carbonate and fluorobenzene. 4-chlorotoluene was added to the mixture as an overcharge-preventing agent. The volume ratio of ethylene carbonate:ethyl methyl carbonate:fluorobenzene:4-chlorotoluene was 25:55:10:10.

### EXAMPLE 2

A lithium rechargeable battery was fabricated as in Example 1, except that the volume ratio of ethylene carbonate:ethyl methyl carbonate:fluorobenzene:4-chlorotoluene in the electrolyte was 25:57.5:10:7.5.

### EXAMPLE 3

A lithium rechargeable battery was fabricated as in Example 1, except that the volume ratio of ethylene carbonate:ethyl methyl carbonate:fluorobenzene:4-chlorotoluene in the electrolyte was 25:60:10:5.

### EXAMPLE 4

A lithium rechargeable battery was fabricated as in Example 1, except that the volume ratio of ethylene carbonate:ethyl methyl carbonate:fluorobenzene:4-chlorotoluene in the electrolyte was 20:60:10:10.

### EXAMPLE 5

A lithium rechargeable battery was fabricated as in Example 1, except that the volume ratio of ethylene carbonate:ethyl methyl carbonate:fluorobenzene:4-chlorotoluene in the electrolyte was 20:62.5:10:7.5.

### EXAMPLE 6

A lithium rechargeable battery was fabricated as in Example 1, except that the volume ratio of ethylene carbonate:ethyl methyl carbonate:fluorobenzene:4-chlorotoluene in the electrolyte was 20:65:10:5.

### EXAMPLE 7

A lithium rechargeable battery was fabricated as in Example 1, except that the volume ratio of ethylene carbonate:ethyl methyl carbonate:fluorobenzene:4-chlorotoluene in the electrolyte was 30:50:10:10 and 1.0 M LiPF₆ was added.

### EXAMPLE 8

A lithium rechargeable battery was fabricated as in Example 1, except that the volume ratio of ethylene carbonate:ethyl methyl carbonate:fluorobenzene:4-chlorotoluene in the electrolyte was 30:50:10:10 and 0.8 M LiPF₆ was added.

### EXAMPLE 9

A lithium rechargeable battery was fabricated in the same manner as in Example 1, except that the volume ratio of ethylene carbonate:ethyl methyl carbonate:fluorobenzene:4-chlorotoluene in the electrolyte was 25:55:10:10 and 1.0 M LiPF₆ was added.

### EXAMPLE 10

A lithium rechargeable battery was fabricated in the same manner as in Example 1, except that the volume ratio of ethylene carbonate:ethyl methyl carbonate:fluorobenzene:4-chlorotoluene in the electrolyte was 25:57.5:10:7.5 and 1.0 M LiPF₆ was added.

### EXAMPLE 11

A lithium rechargeable battery was fabricated in the same manner as in Example 1, except that the volume ratio of ethylene carbonate:ethyl methyl carbonate:fluorobenzene:4-chlorotoluene in the electrolyte was 25:60;10:5 and 1.0 M LiPF₆ was added.

### COMPARATIVE EXAMPLE 1

A lithium rechargeable battery was fabricated as in Example 1, except that 2-chlorotoluene was used as the overcharge-preventing agent in the electrolyte, and the volume ratio of ethylene carbonate:ethyl methyl carbonate:fluorobenzene:4-chlorotoluene was 30:50:10:10.

### COMPARATIVE EXAMPLE 2

A lithium rechargeable battery was fabricated as in Example 1, except that the volume ratio of ethylene carbonate:ethyl methyl carbonate:fluorobenzene:4-chlorotoluene in the electrolyte was 30:52.5:10:7.5.

### COMPARATIVE EXAMPLE 3

A lithium rechargeable battery was fabricated as in Example 1, except that the volume ratio of ethylene carbonate:ethyl methyl carbonate:fluorobenzene:4-chlorotoluene in the electrolyte was 30:55:10:5.

### COMPARATIVE EXAMPLE 4

A lithium rechargeable battery was fabricated as in Example 1, except that 2-chlorotoluene was used as the overcharge-preventing agent in the electrolyte, and the volume ratio of ethylene carbonate:ethyl methyl carbonate:fluorobenzene:2-chlorotoluene was 30:50:10:10.

### COMPARATIVE EXAMPLE 5

A lithium rechargeable battery was fabricated as in Example 1, except that 3-chlorotoluene was used as the overcharge-preventing agent in the electrolyte, and the volume ratio of ethylene carbonate:ethyl methyl carbonate:fluorobenzene:3-chlorotoluene was 30:50:10:10.

### COMPARATIVE EXAMPLE 6

A lithium rechargeable battery was fabricated as in Example 1, except that 2-fluorotoluene was used as the overcharge-preventing agent in the electrolyte, and the volume ratio of ethylene carbonate:ethyl methyl carbonate:fluorobenzene:2-fluorotoluene was 30:50:10:10.

### COMPARATIVE EXAMPLE 7

A lithium rechargeable battery was fabricated as in Example 1, except that 3-fluorotoluene was used as the overcharge-preventing agent in the electrolyte, and the volume ratio of ethylene carbonate:ethyl methyl carbonate:fluorobenzene:3-fluorotoluene was 30:50:10:10.

### COMPARATIVE EXAMPLE 8

A lithium rechargeable battery was fabricated as in Example 1, except that 4-fluorotoluene was used as the overcharge-preventing agent in the electrolyte, and the volume ratio of ethylene carbonate:ethyl methyl carbonate:fluorobenzene:4-fluorotoluene was 30:50:10:10.

### COMPARATIVE EXAMPLE 9

A lithium rechargeable battery was fabricated as in Example 1, except that 2-bromotoluene was used as the overcharge-preventing agent in the electrolyte, and the volume ratio of ethylene carbonate:ethyl methyl carbonate:fluorobenzene:2-bromotoluene was 30:50:10:10.

### COMPARATIVE EXAMPLE 10

A lithium rechargeable battery was fabricated as in Example 1, except that 3-bromotoluene was used as the overcharge-preventing agent in the electrolyte, and the volume ratio of ethylene carbonate:ethyl methyl carbonate:fluorobenzene:3-bromotoluene was 30:50:10:10.

### COMPARATIVE EXAMPLE 11

A lithium rechargeable battery was fabricated as in Example 1, except that 4-bromotoluene was used as the overcharge-preventing agent in the electrolyte, and the volume ratio of ethylene carbonate:ethyl methyl carbonate:fluorobenzene:4-bromotoluene was 30:50:10:10.

The batteries (battery capacity 1 C=790 mAh) fabricated in Examples 1 through 11 and Comparative Examples 1 through 11 were charged to a charge voltage of 4.2 V at a current of 158 mA in constant current/constant voltage conditions. The batteries were then allowed to stand for 1 hour. The charged batteries were then discharged to a voltage of 2.75 V at a current of 395 mA, followed by standing for 1 hour. This charge/discharge procedure was repeated three times, and the batteries were then charged to a charge voltage of 4.2 V at a current of 395 mA for 3 hours.

Overcharge Tests

Twenty batteries were fabricated according to each of Examples 1 through 11 and Comparative Examples 1 through 11 were overcharged from a charged condition at room temperature (25° C.) under constant current/constant voltage at 1 C (790 mAh)/12 V for two hours and 30 minutes. The state of each of the batteries was then examined and the results are shown in Table 1 below.

Low-Temperature Discharge Capacity Test

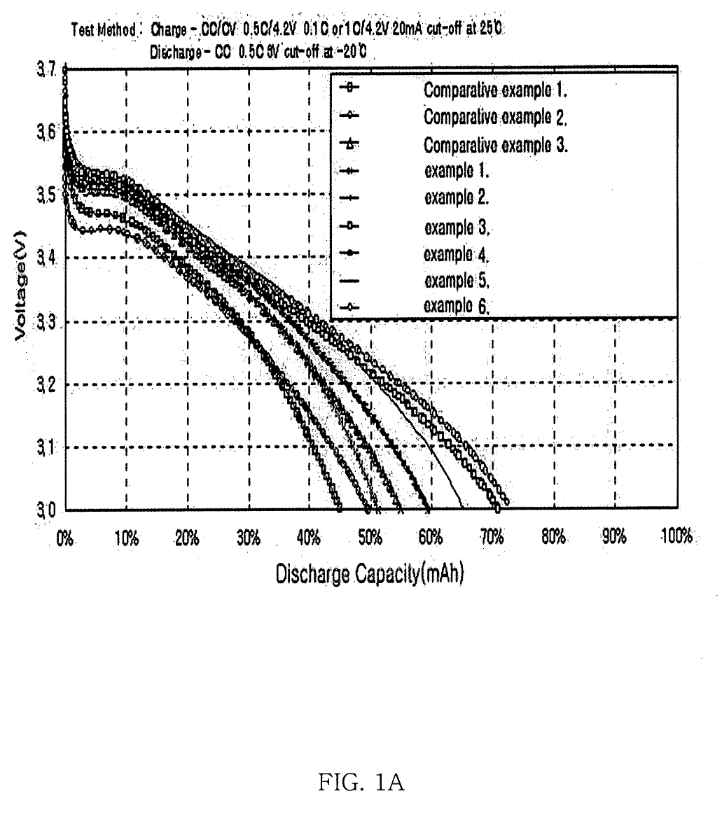

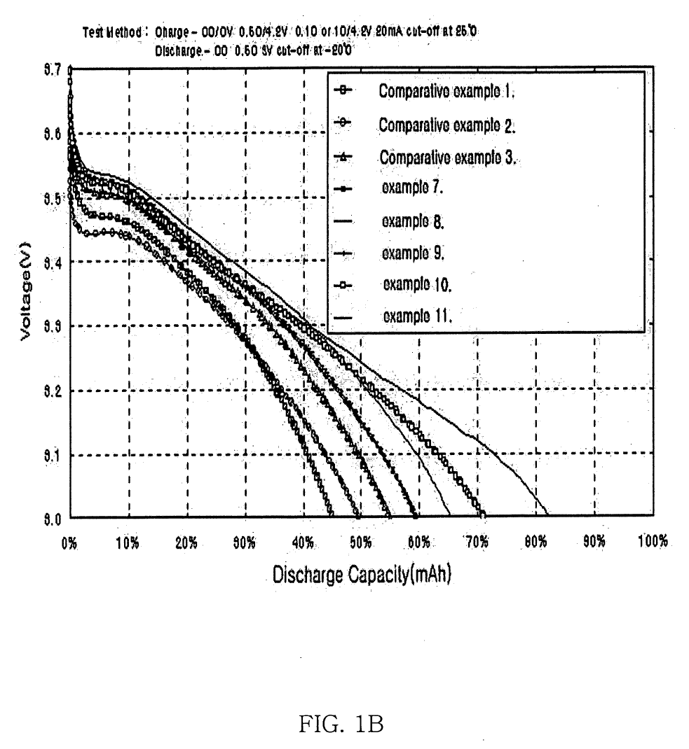

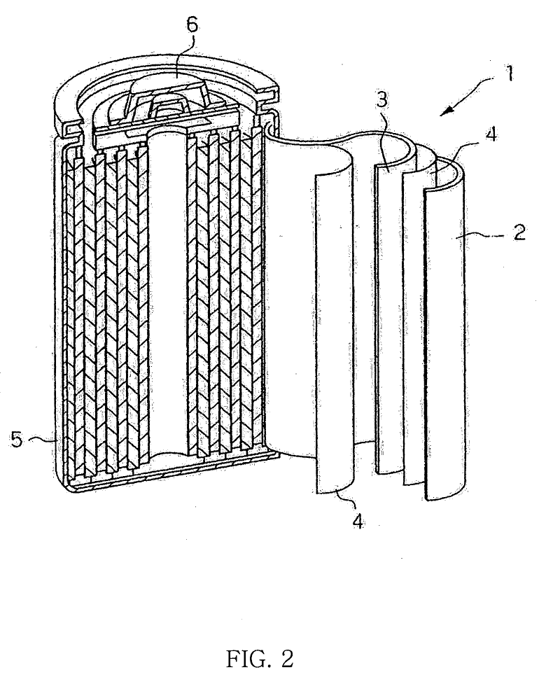

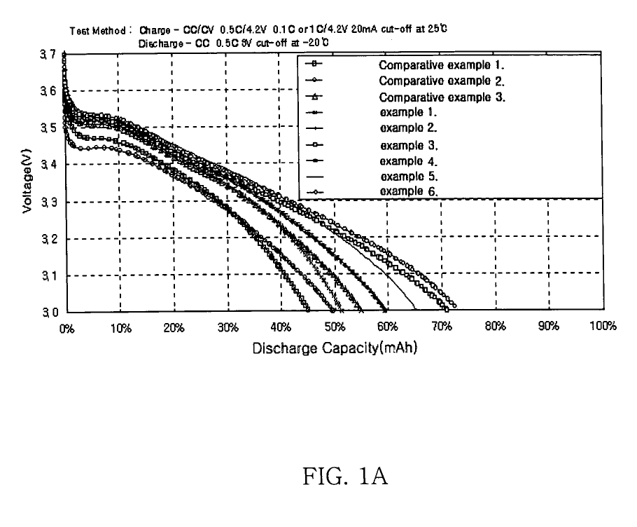

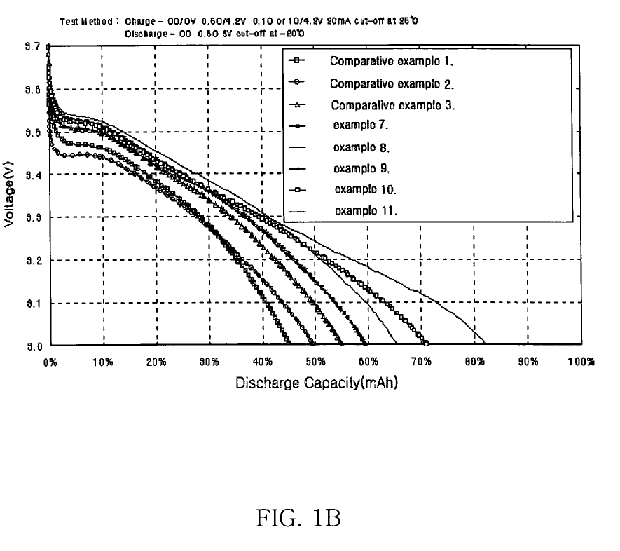

The batteries were either charged at room temperature (25° C.) at a cut-off current of 0.1 C under constant current/constant voltage at 0.5 C/4.2 V, or charged at a cut-off current of 20 mA under constant current/constant voltage conditions at 1 C/4.2 V. The batteries were then allowed to stand at −20° C. for 16 hours, and then cut-off discharged at 0.5 C/3 V. The low-temperature discharge characteristics of the batteries were evaluated and the results are shown in Table 1 below. The low-temperature discharge characteristics of Examples 1 through 11 and Comparative Examples 1 through 3 are also shown in FIGS. 1a and 1b.

Cycle Life Test

The batteries were cut-off charged at 0.1 C under constant current/constant voltage at 1 C/4.2 V, cut-off discharged under constant current/constant voltage at 1 C/3.0V and then evaluated for cycle life characteristics at 300 cycles. The results are shown in Table 1 below.

In Table 1 below, evaluation standards for overcharge safety are as follows:

L0: good; L1: leakage; L2: flash; L2: flame; L3: smoke; L4: fire catching; and L5: explosion.

The numbers before the letter “L” refer to the number of batteries tested that exhibit the reported rating. For example, 20L0 means that 20 tested batteries all have good overcharge safety characteristics.

In Table 1, EC is ethylene carbonate, EMC is ethyl methyl carbonate, and FB is fluorobenzene.

TABLE 1

| | Electrolyte | | | Dis- | |
|---|---|---|---|---|---|
| | composition | | | charge | Ca- |
| | | Lithium | Over- | ca- | pacity |
| | Solvent | salt | charge | pacity | (%) at |
| | Composition | (Concen- | Re- | (%) at | 300 |
| | (vol %) | tration) | sults | −20° C. | cycles |
| Example 1 | EC:EMC:FB:4- | LiPF₆ | 20L0 | 50 | 75 |
| | chlorotoluene = | (1.3 M) | | | |
| | 25:55:10:10 | | | | |
| Example 2 | EC:EMC:FB:4- | LiPF₆ | 20L0 | 60 | 80 |
| | chlorotoluene = | (1.3 M) | | | |
| | 25:57.5:10:7.5 | | | | |
| Example 3 | EC:EMC:FB:4- | LiPF₆ | 20L0 | 70 | 85 |
| | chlorotoluene == | (1.3 M) | | | |
| | 25:60:10:5 | | | | |
| Example 4 | EC/EMC/FB/4- | LiPF₆ | 20L0 | 60 | 70 |
| | chlorotoluene = | (1.3 M) | | | |
| | 20/60/10/10 | | | | |
| Example 5 | EC:EMC:FB:4- | LiPF₆ | 20L0 | 65 | 72 |
| | chlorotoluene = | (1.3 M) | | | |
| | 20:62.5:10:7.5 | | | | |
| Example 6 | EC/EMC/FB/4- | LiPF₆ | 20L0 | 72 | 73 |
| | chlorotoluene = | (1.3 M) | | | |
| | 20/65/10/5 | | | | |
| Example 7 | EC:EMC:FB:4- | LiPF₆ | 20L0 | 60 | 79 |
| | chlorotoluene = | (1.0 M) | | | |
| | 30:50:10:10 | | | | |
| Example 8 | EC:EMC:FB:4- | LiPF₆ | 20L0 | 65 | 75 |
| | chlorotoluene = | (0.8 M) | | | |
| | 30:50:10:10 | | | | |
| Example 9 | EC:EMC:FB:4- | LiPF₆ | 20L0 | 60 | 76 |
| | chlorotoluene = | (1.0 M) | | | |
| | 25:55:10:10 | | | | |
| Example 10 | EC:EMC:FB:4- | LiPF₆ | 20L0 | 70 | 79 |
| | chlorotoluene = | (1.0 M) | | | |
| | 25:57.5:10:7.5 | | | | |
| Example 11 | EC:EMC:FB:4- | LiPF₆ | 20L0 | 82 | 83 |
| | chlorotoluene = | (1.0 M) | | | |
| | 25:60:10:5 | | | | |
| Comparative | EC:EMC:FB:4- | LiPF₆ | 20L0 | 45 | 80 |
| Example 1 | chlorotoluene = | (1.3 M) | | | |
| | 30:50:10:10 | | | | |
| Comparative | EC:EMC:FB:4- | LiPF₆ | 20L0 | 50 | 85 |
| Example 2 | chlorotoluene = | (1.3 M) | | | |
| | 30:52.5:10:7.5 | | | | |
| Comparative | EC:EMC:FB:4- | LiPF₆ | 20L0 | 55 | 90 |
| Example 3 | chlorotoluene = | (1.3 M) | | | |
| | 30:55:10:5 | | | | |
| Comparative | EC:EMC:FB:2- | LiPF₆ | 4L3, | 40 | 75 |
| Example 4 | chlorotoluene = | (1.3 M) | 16L4 | | |
| | 30:50:10:10 | | | | |
| Comparative | EC:EMC:FB:3- | LiPF₆ | 5L3, | 42 | 76 |
| Example 5 | chlorotoluene = | (1.3 M) | 15L4 | | |
| | 30:50:10:10 | | | | |
| Comparative | EC:EMC:FB:2- | LiPF₆ | 2L3, | 43 | 69 |
| Example 6 | fluorotoluene = | (1.3 M) | 18L5 | | |
| | 30:50:10:10 | | | | |
| Comparative | EC:EMC:FB:3- | LiPF₆ | 5L4, | 42 | 70 |
| Example 7 | fluorotoluene = | (1.3 M) | 15L5 | | |
| | 30:50:10:10 | | | | |
| Comparative | EC:EMC:FB:4- | LiPF₆ | 15L0, | 41 | 60 |
| Example 8 | fluorotoluene = | (1.3 M) | 5L3 | | |
| | 30:50:10:10 | | | | |
| Comparative | EC:EMC:FB:2- | LiPF₆ | 4L3, | 34 | 70 |
| Example 9 | bromotoluene = | (1.3 M) | 16L4 | | |
| | 30:50:10:10 | | | | |
| Comparative | EC:EMC:FB:3- | LiPF₆ | 4L4, | 35 | 71 |
| Example 10 | bromotoluene = | (1.3 M) | 16L5 | | |
| | 30:50:10:10 | | | | |
| Comparative | EC:EMC:FB:4- | LiPF₆ | 16L0, | 33 | 65 |
| Example 11 | bromotoluene = | (1.3 M) | 4L4 | | |
| | 30:50:10:10 | | | | |

As shown in the results listed for Examples 1 through 6 and Comparative Examples 7 through 11 in Table 1 above, among the toluene compounds substituted with a halogen, the toluene compounds substituted with Cl exhibited excellent overcharge-preventing characteristics as compared to the toluene compounds substituted with Br or F. In particular, as shown in the results listed for Comparative Example 1 and Comparative Examples 4 through 5, when a toluene compound substituted with Cl at the para-position (e.g. 4-chlorotoluene) was added, the overcharge test results were all good. This suggests that the toluene compound substituted with Cl at the para-position has excellent overcharge-preventing characteristics as compared to compounds substituted with Cl at the ortho- or meta-positions.

As shown in the results listed for Examples 1 through 11 and Comparative Examples 1 through 3, electrolytes containing 5 to 10 vol % of the toluene compound substituted with Cl at the para-position exhibited improved low-temperature discharge characteristics when either the ethylene carbonate (cyclic carbonate) was reduced or the concentration of the lithium salt was reduced. Also, the capacity maintenance of the batteries after 300 cycles was 70 to 85%, indicating that the cycle life characteristics of the batteries can be maintained upon a reduction in ethylene carbonate or a reduction in the concentration of the lithium salt. In particular, Example 11 (where both the ethylene carbonate content and the lithium salt concentration were reduced) exhibited the highest low-temperature discharge capacity. However, Comparative Examples 1 through 3 (where the ethylene carbonate was present in an amount more than 25 vol % and the 4-chlorotoluene was added in an amount ranging from 5 to 10 vol %) exhibited good overcharge safety characteristics but rapidly deteriorated low-temperature discharge characteristics.

As described above, the electrolytes according to the present invention improve the low-temperature discharge and cycle life characteristics of lithium rechargeable batteries while maintaining the overcharge safety of the batteries.

Exemplary embodiments of the present invention have been described for illustrative purposes. However, those skilled in the art will appreciate that various modifications, additions and substitutions can be made without departing from the spirit and scope of the invention as disclosed in the accompanying claims.

What is claimed is:

1. An electrolyte for a lithium rechargeable battery, the electrolyte comprising:
a lithium salt;
a non-aqueous organic solvent comprising a cyclic carbonate and a linear carbonate, wherein the cyclic carbonate is present in the electrolyte in an amount ranging from about 20 to about 25% by volume based on the total volume of the electrolyte; and
an electrolyte additive represented by Formula 1: 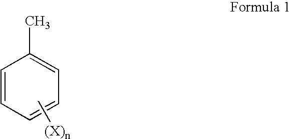
wherein X is Cl, n is an integer ranging from 1 to 5, and at least one Cl is substituted at the para-position;
wherein the electrolyte additive is present in the electrolyte in an amount ranging from about 5 to about 10% by volume based on the total volume of the electrolyte.

2. The electrolyte of claim 1, wherein the electrolyte additive is selected from the group consisting of 4-chlorotoluene, 2,4-dichlorotoluene, 3,4-dichlorotoluene, 2,3,4-trichlorotoluene, 3,4,5-trichlorotoluene, 2,3,4,5-tetrachlorotoluene, 2,3,4,6-tetrachlorotoluene, 2,3,4,5,6-pentachlorotoluene, and mixtures thereof.

3. The electrolyte of claim 1, wherein the electrolyte additive is 4-chlorotoluene.

4. The electrolyte of claim 1, wherein the cyclic carbonate is selected from the group consisting of ethylene carbonate, propylene carbonate, 1,2-butylene carbonate, 2,3-butylene carbonate, 1,2-pentylene carbonate, 2,3-pentylene carbonate, vinylene carbonate (VC) and mixtures thereof.

5. The electrolyte of claim 1, wherein the linear carbonate is selected from the group consisting of dimethyl carbonate (DMC), diethyl carbonate (DEC), dipropyl carbonate (DPC), methyl propyl carbonate (MPC), ethyl methyl carbonate (EMC) ethyl propyl carbonate (EPC) and mixtures thereof.

6. The electrolyte of claim 1, wherein the non-aqueous organic solvent further comprises an organic aromatic hydrocarbon solvent.

7. The electrolyte of claim 6, wherein the organic aromatic hydrocarbon solvent is selected from the group consisting of compounds represented by Formula 2: 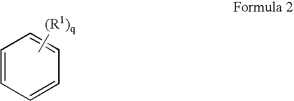
wherein R¹ is selected from the group consisting of halogen atoms and alkyl groups having 1 to 10 carbon atoms, and q is an integer ranging from 0 to 6.

8. The electrolyte of claim 7, wherein the organic aromatic hydrocarbon solvent is selected from the group consisting of benzene, fluorobenzene, bromobenzene, chlorobenzene, toluene, xylene, mesitylene and mixtures thereof.

9. The electrolyte of claim 6, wherein the cyclic and linear carbonates and the organic aromatic hydrocarbon solvent are mixed in a volume ratio ranging from about 1:1 to about 30:1.

10. An electrolyte for a lithium rechargeable battery, the electrolyte comprising:
a lithium salt having a concentration ranging from about 0.8 to about 1.2 M;
a non-aqueous organic solvent comprising a cyclic carbonate and a linear carbonate; and
an electrolyte additive represented by Formula 1: 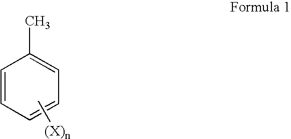
wherein X is Cl, n is an integer ranging from 1 to 5, and at least one Cl is substituted at the para-position;
wherein the electrolyte additive is present in the electrolyte in an amount ranging from about 5 to about 10% by volume based on the total volume of the electrolyte.

11. The electrolyte of claim 10, wherein the lithium salt has a concentration ranging from about 0.8 to about 1.0 M.

12. The electrolyte of claim 10, wherein the lithium salt is selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₄, LiAlCl₄, LiN(CₓF₂ₓ₊₁SO₂)(C_{y}F2_{y+1}SO₂) where each of x and y is a natural number, LiCl, Lil, and mixtures thereof.

13. The electrolyte of claim 10, wherein the electrolyte additive is selected from the group consisting of 4-chlorotoluene, 2,4-dichlorotoluene, 3,4-dichlorotoluene, 2,3,4-trichlorotoluene, 3,4,5-trichlorotoluene, 2,3,4,5-tetrachlorotoluene, 2,3,4,6-tetrachlorotoluene, 2,3,4,5,6-pentachlorotoluene, and mixtures thereof.

14. The electrolyte of claim 13, wherein the electrolyte additive is 4-chlorotoluene.

15. The electrolyte of claim 10, wherein the cyclic carbonate is present in the electrolyte in an amount ranging from about 20 to about 25% by volume based on the total volume of the electrolyte.

16. The electrolyte of claim 10, wherein the cyclic carbonate is selected from the group consisting of ethylene carbonate, propylene carbonate, 1,2-butylene carbonate, 2,3-butylene carbonate, 1,2-pentylene carbonate, 2,3-pentylene carbonate, vinylene carbonate (VC), and mixtures thereof.

17. The electrolyte of claim 10, wherein the linear carbonate is selected from the group consisting of dimethyl carbonate, diethyl carbonate, dipropyl carbonate, methyl propyl carbonate, ethyl methyl carbonate, ethyl propyl carbonate, and mixtures thereof.

18. The electrolyte of claim 10, wherein the non-aqueous organic solvent further comprises an organic aromatic hydrocarbon solvent.

19. The electrolyte of claim 18, wherein the organic aromatic hydrocarbon solvent is selected from the group consisting of compounds represented by Formula 2: 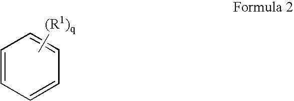
wherein R¹ is selected from the group consisting of halogen atoms and alkyl groups having 1 to 10 carbon atoms, and q is an integer ranging from 0 to 6.

20. The electrolyte of claim 19, wherein the organic aromatic hydrocarbon solvent is selected from the group consisting of benzene, fluorobenzene, bromobenzene, chlorobenzene, toluene, xylene, mesitylene, and mixtures thereof.

21. The electrolyte of claim 18, wherein the cyclic and linear carbonates and the organic aromatic hydrocarbon solvent are mixed in a volume ratio ranging from about 1:1 to about 30:1.

22. A lithium rechargeable battery comprising:
a positive electrode comprising a positive active material capable of intercalating and deintercalating lithium ions;
a negative electrode comprising a negative active material capable of intercalating and deintercalating lithium ions; and
the electrolyte of claim 1.

23. The lithium rechargeable battery of claim 22, wherein the positive active material is selected from the group consisting of lithium-containing transition metal compounds and lithium chalcogenide compounds.

24. The lithium rechargeable battery of claim 23, wherein the positive active material is selected from the group consisting of LiCoO₂, LiNiO₂, LiMnO₂, LiMn₂O₄, and LiNi_{1-x-y}CoₓM_{y}O₂ where 0≦x≦1, 0≦y≦1, 0≦x+y≦1 and M is selected from the group consisting of Al, Sr, Mg, and La.

25. The lithium rechargeable battery of claim 22, wherein the negative active material is selected from the group consisting of crystalline carbon, amorphous carbon, carbon composites, carbon fibers, lithium metals and lithium alloys.

26. A lithium rechargeable battery comprising:
a positive electrode comprising a positive active material capable of intercalating and deintercalating lithium ions;
a negative electrode comprising a negative active material capable of intercalating and deintercalating lithium ions; and
an electrolyte comprising:
a lithium salt;
a non-aqueous organic solvent comprising a cyclic carbonate and a linear carbonate, wherein the cyclic carbonate is present in the electrolyte in an amount ranging from about 20 to about 25% by volume based on the total volume of the electrolyte; and
an electrolyte additive represented by Formula 1: 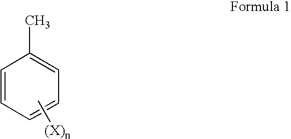
wherein X is Cl, n is an integer ranging from 1 to 5, and at least one Cl is substituted at the para-position;
wherein the electrolyte additive is present in the electrolyte in an amount ranging from about 5 to about 10% by volume based on the total volume of the electrolyte.

27. A lithium rechargeable battery comprising:
a positive electrode comprising a positive active material capable of intercalating and deintercalating lithium ions;
a negative electrode comprising a negative active material capable of intercalating and deintercalating lithium ions; and
an electrolyte comprising:
a lithium salt having a concentration ranging from about 0.8 to about 1.2 M;
a non-aqueous organic solvent comprising a cyclic carbonate and a linear carbonate; and
an electrolyte additive represented by Formula 1: 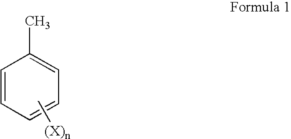
wherein X is Cl, n is an integer ranging from 1 to 5, and at least one Cl is substituted at the para-position;
wherein the electrolyte additive is present in the electrolyte in an amount ranging from about 5 to about 10% by volume based on the total volume of the electrolyte.
